(19) United States
(12) Patent Application Publication
(10) Pub. No.: US 2021/0144965 A1
(43) Pub. Date: May 20, 2021

(54) TAG WITH DETACHMENT DETECTION FEATURE

(71) Applicant: Sony Corporation, Tokyo (JP)

(72) Inventors: Peter EXNER, Lund (SE); Sangxia HUANG, Lund (SE)

(21) Appl. No.: 17/047,580

(22) PCT Filed: Feb. 20, 2019
(86) PCT No.: PCT/US2019/018708

§ 371 Date: Oct. 14, 2020

(30) Foreign Application Priority Data
Apr. 18, 2018 (SE) 1830131-7

(51) Int. Cl. A01K 11/00; G06K 19/07

(52) U.S. Cl. CPC A01K 11/004; G06K 19/0718; G06K 19/0717

(57) ABSTRACT

A tag (10) is configured to be attached to an object (12). The tag includes a sensor (24) configured to generate data indicative of movement of the tag in three dimensions. A control circuit (14) of the tag is configured to determine an amount of change in orientation of the tag over a predetermined period of time based on the data indicative of movement of the tag in three dimensions generated by the sensor; and to determine that the amount of change in orientation indicates that the tag is in one of an attached state relative to the object or is in a detached state relative to the object. A signal may be transmitted to a host computing device (28) if it is determined that the tag has become detached from the object.

### TECHNICAL FIELD OF THE INVENTION

The technology of the present disclosure relates generally to tags used for tracking or identifying objects and, more particularly, to a tag having features to detect if it has become detached from an object to which it is intended to be attached and optionally communicate a detached state to another device.

### BACKGROUND

Tags are often attached to objects to help uniquely identify the object or to monitor a condition related to the object. Farmers often use tags of this nature on livestock, such as pigs, cows, chickens and so forth. Tags of this nature also may be attached to wild animals, equipment, machines, or other items.

An exemplary tag for livestock may include an accelerometer assembly as a sensor that enables tracking and monitoring of the animal's health. For instance, accelerometer data may be analyzed to detect animal activities and used to identify patterns related to health issues. Other sensors may include a thermometer for taking the temperature of the animal, a heart rate monitor, or other sensor.

But retention of the tag on the intended object has become an issue. For instance, in the case of livestock, when the animal engages in biting, scratching or other activity, the tag might become detached from the animal. In this case, the detached tag may continue to collect and/or transmit data and this data may resemble data indicative of the animal lying down or sleeping. Other than manual detection by the keeper of the livestock, it will be unknown that the tag has become detached.

Existing solutions to this issue focus on prevention of tag detachment by enhancing the physical construction of the tag and/or placement of the tag on the animal to lower the loss rate. But these efforts can use more invasive attachment techniques to the animal.

### SUMMARY

The disclosed approach includes analyzing data generated by a sensor (e.g., an accelerometer assembly) in the tag to determine if the tag is attached or detached from the intended object. In the event of a detached state, the tag may send a message to another device to alert an appropriate person or take some other automated action. In this manner, the detached state may be remedied sooner. In the context of tagged livestock, the knowledge of which animals have become detached from corresponding tags can have value, such as when tracking hundreds or thousands of animals.

According to one aspect of the disclosure, a tag is configured to be attached to an object. The tag includes a sensor configured to generate data indicative of movement of the tag in three dimensions; and a control circuit configured to: determine an amount of change in orientation of the tag over a predetermined period of time based on the data indicative of movement of the tag in three dimensions generated by the sensor; and determine that the amount of change in orientation indicates that the tag is in one of an attached state relative to the object or is in a detached state relative to the object.

According to one embodiment of the tag, the tag further includes a communications circuit and the tag is configured to, upon determination that the tag is in the detached state relative to the object, output a signal indicating the detached state of the tag over the communications circuit to a host computing system.

According to one embodiment of the tag, the sensor is an accelerometer assembly.

According to one embodiment of the tag, determining the amount of change in the orientation includes: sampling data output by the accelerometer assembly at a plurality of points in time; and normalizing each sample.

According to one embodiment of the tag, the samples are taken at predetermined intervals.

According to one embodiment of the tag, determining the amount of change in the orientation further includes comparing each normalized sample with a prior normalized sample to determine a rotational shift value between each pair of compared samples.

According to one embodiment of the tag, the determining the amount of change in orientation further includes carrying out a predetermined operation on a plurality of the normalized samples to determine one or more rotation shift values.

According to one embodiment of the tag, the tag is determined to be in the detached state if the rotational shift values show rotational shift of less than a predetermined threshold over the predetermined amount of time.

According to one embodiment of the tag, the determining that the amount of change in orientation indicates that the tag is in the one of the attached state relative to the object or is in the detached state relative to the object includes conducting a statistical analysis of the rotational shift values.

According to one embodiment of the tag, the object is a livestock animal.

According to one embodiment of the tag, one or more thresholds used in determining that the amount of change in orientation indicates that the tag is in the one of the attached state relative to the object or is in the detached state relative to the object is dependent on the type of animal.

According to one embodiment of the tag, one or more thresholds used in determining that the amount of change in orientation indicates that the tag is in the one of the attached state relative to the object or is in the detached state relative to the object is established using a learning algorithm.

According to another aspect of the disclosure, an object tracking system includes a plurality of tags, each tag is associated with a corresponding one of a plurality objects; and a host computing system, the host computing system collecting data regarding the plurality of objects.

According to one embodiment of the object tracking system, the host computing system applies a learning algorithm to change settings used in the determining that the amount of change in orientation indicates that the tag is in the one of the attached state relative to the object or is in the detached state relative to the object to increase accuracy of the determination.

According to another aspect of the disclosure, a method of determining attachment of a tag to an object includes: collecting sensor output data indicative of movement of the tag in three dimensions; determining an amount of change in orientation of the tag over a predetermined period of time from the data indicative of movement of the tag in three dimensions; and determining that the amount of change in orientation indicates that the tag is in one of an attached state relative to the object or is in a detached state relative to the object.

According to one embodiment of the method, the method further includes, upon determination that the tag is in the detached state relative to the object, outputting a signal indicating the detached state of the tag to a host computing system.

According to one embodiment of the method, the sensor is an accelerometer assembly and determining the amount of change in the orientation includes: sampling data output by the accelerometer assembly at a plurality of points in time; and normalizing each sample.

According to one embodiment of the method, the samples are taken at predetermined intervals.

According to one embodiment of the method, determining the amount of change in the orientation further includes comparing each normalized sample with a prior normalized sample to determine a rotational shift value between each pair of compared samples.

According to one embodiment of the method, the determining the amount of change in orientation further includes carrying out a predetermined operation on a plurality of the samples to determine one or more rotation shift values.

According to one embodiment of the method, the tag is determined to be in the detached state if the rotational shift values show rotational shift of less than a predetermined threshold over the predetermined amount of time.

According to one embodiment of the method, the determining that the amount of change in orientation indicates that the tag is in the one of the attached state relative to the object or is in the detached state relative to the object includes conducting a statistical analysis of the rotational shift values.

### BRIEF DESCRIPTION OF THE DRAWINGS

FIG. 1 schematically shows a tag having features to detect if the tag has become detached from an object, the tag is shown in a state attached to a representative object.

FIG. 2 is a schematic diagram showing the tag, the tag is shown as part of a system.

FIG. 3 is a flow diagram of a representative method of determining attachment state of the tag to the object.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below, in conjunction with the appended figures, are various embodiments of tags, systems and methods that determine attachment state of a tag to an object.

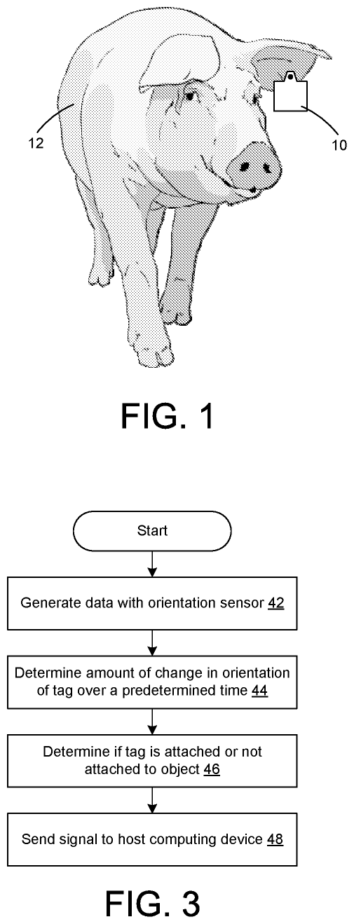

FIG. 1 shows a tag 10 attached to an object 12. In the illustrated embodiment, the object 12 is an animal maintained as livestock with a number of other similar animals. The animal of the illustrated embodiment is a pig. It will be understood that the tag may be used with other types of animals or with other types of objects, which need not be living.

In the exemplary context shown in FIG. 1, the tag 10 is attached to the pig with a piercing through an ear of the pig. Other attachment mechanisms may be employed and the attachment mechanism may be changed depending on the type of object 12 to which the tag 10 is attached. For instance, in the case of a bird, the tag 10 may be pierced to a wing of the bird. Alternatively, the tag 10 may be attached using a band placed around a leg of the animal. In the case of non-living objects, the tag may be attached with adhesive, a strap, a threaded fastener, or any other appropriate connector.

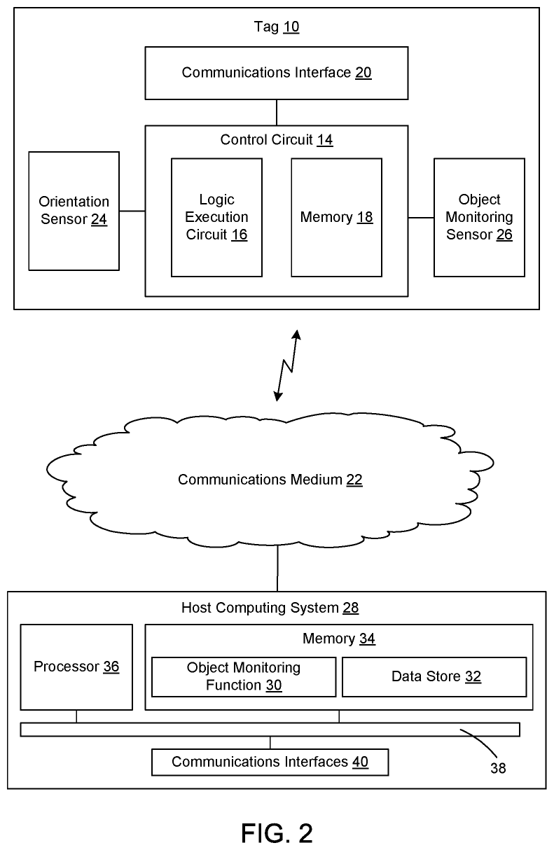

With additional reference to FIG. 2, illustrated is an exemplary system for implementing the disclosed techniques. It will be appreciated that the illustrated system is representative and other systems may be used to implement the disclosed techniques.

The system includes the tag 10. The tag 10 is configured to carry out associated logical functions that are described herein. The tag 10 includes a control circuit 14 that is responsible for overall operation of the tag 10. The tag 10 may include a logic execution circuit 16, such as a processor, that executes code to carry out various functions of the tag 10. Logical functions and/or hardware of the tag 10 may be implemented in other manners depending on the nature and configuration of the tag 10. Therefore, the illustrated and described approaches are just examples and other approaches may be used including, but not limited to, the control circuit 14 being implemented as, or including, hardware (e.g., a microprocessor, microcontroller, central processing unit (CPU), etc.) or a combination of hardware and software (e.g., a system-on-chip (SoC), an application-specific integrated circuit (ASIC), field programmable gate array (FPGA), etc.).

The code executed by the logic execution circuit 16 and data stored by the tag 10 may be stored by a memory 18. The stored data may include, but is not limited to, data associated with the attachment determination functions of the tag 10.

The memory 18 may be, for example, one or more of a buffer, a flash memory, a hard drive, a removable media, a volatile memory, a non-volatile memory, a random access memory (RAM), or other suitable device. In a typical arrangement, the memory 18 includes a non-volatile (persistent) memory for long term data storage and a volatile memory that functions as system memory for the control circuit 14. The memory 18 is considered a non-transitory computer readable medium.

In some embodiments, the tag 10 includes a communications interface 20 (e.g., communications circuitry) that enables the tag 10 to transmit messages in broadcast format (e.g., without the establishment of a session with another device and/or without the expectation of a return response) or to establish a wireless communication connection with another device over a communications medium 22 and send messages via the wireless communication connection. In the exemplary embodiment, the communications interface 20 includes a radio circuit. The radio circuit includes one or more radio frequency transceivers and at least one antenna assembly. Wired communications interfaces also may be present. In the embodiment where the communications interface 20 is operational to establish a wireless communication connection, the communications interface 20 and communications medium 22 may include coordinating transceivers. Exemplary transceivers include, but are not limited to, a cellular radio, a WiFi radio, a Bluetooth radio, a Bluetooth low energy (BLE) radio, or any other appropriate radio frequency transceiver. Also, an appropriate protocol may be followed by the communications interface 20 and/or the communications medium 22, such as a 3G, 4G or 5G protocol, an Internet or Things (IoT) protocol, a machine to machine (M2M) protocol, a WiFi protocol, a Bluetooth or BLE protocol, etc.

The tag 10 has an orientation sensor 24 configured to generate data indicative of movement of the tag 10 in three dimensions. In one embodiment, the orientation sensor 24 is a three axis accelerometer assembly. Another embodiment of the orientation sensor 24 is a gyro assembly.

The tag 10 may include other sensors or components, such as an object monitoring sensor 26 or sensors 26. The object monitoring sensor 26 may be a thermometer, a heart rate monitor, a vibration sensor, a camera, a microphone, or any other appropriate device. Although not shown, the tag 10 may further include a power supply unit that includes a battery for delivering operational power to the other components of the tag 10. The battery may be rechargeable.

Detachment notifications and/or data may be transmitted from the tag 10 to a host computing system 28, such as a server, a personal computer, a portable user equipment (e.g., a smartphone), etc. The host computing system 28 may be implemented as a computer-based system that is capable of executing computer applications (e.g., software programs). An exemplary application includes an object monitoring function 30. The object monitoring function 30, when executed, carries out functions of the host computing system 28 that are described herein. The object monitoring function 30, any other applications and an operating system executed by the host computing system 28, and a data store 32 may be stored on a non-transitory computer readable medium, such as a memory 34. The data store 32 may be used to store various information sets used to carry out the functions described in this disclosure. The memory 34 may be, for example, a magnetic, optical or electronic storage device (e.g., hard disk, optical disk, flash memory, etc.), and may comprise several devices, including volatile and non-volatile memory components. Accordingly, the memory 34 may include, for example, random access memory (RAM) for acting as system memory, read-only memory (ROM), solid-state drives, hard disks, optical disks, tapes, flash devices and/or other memory components, plus associated drives, players and/or readers for the memory devices.

To execute logical operations, the host computing system 28 may include one or more processors 36 used to execute instructions that carry out logic routines. The processor 36 and the memory 34 may be coupled using a local interface 38. The local interface 38 may be, for example, a data bus with accompanying control bus, a network, or other subsystem.

The host computing system 28 may have various input/output (I/O) interfaces for operatively connecting to various peripheral devices. The host computing system 28 also may have one or more communications interfaces 40. The communications interface 40 may include for example, a modem and/or a network interface card. The communications interface 40 enables the host computing system 28 to send and receive data to and from other computing devices via the communications medium 22. Also, the communications interface 40 enables the host computing system 28 to receive messages and data from the tag 10 either directly or by way of the communications medium 22. The communications medium 22 may be any network platform and may include multiple network platforms. Exemplary network platforms include, but are not limited to, a WiFi network, a cellular network, etc.

With additional reference to FIG. 3, shown is an exemplary flow diagram representing steps that may be carried out by the tag 10 to determine an attachment state of the tag 10 relative to the object 21. FIG. 3 illustrates an exemplary process flow and, although illustrated in a logical progression, the illustrated blocks may be carried out in other orders and/or with concurrence between two or more blocks. Therefore, the illustrated flow diagram may be altered (including omitting steps) and/or may be implemented in an object-oriented manner or in a state-oriented manner.

The logical flow may start in block 42. In block 42, the orientation sensor 24 is used to generate data indicative of movement of the tag in three dimensions. In one embodiment, the orientation sensor 24 is an accelerometer assembly that outputs raw accelerometer signals for three mutually orthogonal axes (e.g., an x-axis, a y-axis and a z-axis).

Next, in block 44, the control circuit 14 determines an amount of change in orientation of the tag 10 over a predetermined period of time based on the data indicative of movement of the tag 10 in three dimensions that was generated by the sensor 24. In the embodiment where the sensor 24 is an accelerometer assembly, the determination of block 44 may include sampling the data output by the accelerometer assembly at a plurality of points in time. For example, the raw accelerometer signals output by the accelerometer assembly are sampled along the three mutually orthogonal axes. The samples may be taken with a predetermined interval between each sample (e.g., the samples are taken at a predetermined sampling rate). Exemplary sampling rates include 10 milliseconds (ms), 1 second, 5 seconds, etc. In one embodiment, the samples are taken continuously. In other embodiments, if a continuous stream of samples is not needed, a predetermined number of samples are taken during a series of sampling activity periods with a predetermined interval between each sampling activity period. The predetermined number of samples taken during each sampling activity period may be taken at the predetermined sampling rate.

The determination of block 44 also may include normalizing the samples according to a conventional normalization technique. For instance, raw accelerometer magnitudes may be normalized by using the Euclidean norm.

The determination of block 44 also may include determining a rotational shift of the tag 10 by comparing normalized magnitudes within a time frame. In one embodiment, each normalized sample may be compared with a prior normalized sample to determine a rotational shift value between each pair of compared samples. In an implementation of this embodiment, the current normalized sample may be compared against the immediately prior normalized sample to determine how much rotation of the tag occurred during the time between the taking of the samples. In other implementations of this embodiment, the current normalized sample may be compared against a historical sample, such as a sample taken one minute earlier or some other amount of time.

In another exemplary embodiment, the determining the amount of change in orientation includes carrying out a predetermined operation on a plurality of the normalized samples to determine one or more rotation shift values. For example, the predetermined operation may include averaging a first group of samples (e.g., the five most recent samples), separately averaging a second group of samples collected prior to the first group of samples (e.g., the five samples immediately prior to the five most recent samples or the five samples taken one minute, two minutes or five minutes before the current five samples), and comparing the averages to determine how much rotation of the tag occurred during the corresponding period of time.

If the rotational shift is continuously lower than a pre-establish threshold during a pre-establish period of time, a detachment of the tag 10 from the object 12 may be determined to have occurred. For example, in block 46, the control circuit 14 determines that the amount of change in orientation from block 44 indicates that the tag 10 is in an attached state relative to the object 12 or is in a detached state relative to the object 12. If the rotational shift values shown little change in orientation, then a conclusion may be made that the tag 10 is no longer attached to an object 12 that has a propensity to move and is, therefore in a detached state. On the other hand, if the rotational shift values shown change in orientation, then a conclusion may be made that the tag 10 is still attached to the object 12 that has a propensity to move and is, therefore in an attached state.

In one approach, the tag 10 may be determined to be in the detached state if one or more rotational shift values determined in block 44 show rotational shift of less than a predetermined threshold over the predetermined amount of time. For this determination, rotational shift values may be compared individually to the threshold and if the values stay below the threshold for a predetermined amount of time (e.g., an hour or two hours), the detached determination may be made. In another embodiment, the rotational values over a predetermined amount of time (e.g., an hour or two hours) may be combined (e.g., summed or averaged) and if the combined value is below the threshold, the detached determination may be made.

In other embodiments, determining that the amount of change in orientation indicates that the tag 10 is in the one of the attached state relative to the object 12 or is in the detached state relative to the object 12 includes conducting a statistical analysis of the rotational shift values for a predetermined amount of time. Statistical analysis may include a variety of operations including, without limitation, averaging rotational shift values over time, weighting more recent values over older values (or vice versa), comparing an average over time to a standard deviation in rotational shift values, making statistical calculations, etc. Also, filtering may be made to filter out outlier values. For instance, large-scale rotation over a short time period that is surrounded by little or no rotation may be excluded since the large-scale movement might be the result of an animal stepping on a detached tag.

The foregoing approaches may be implemented to discern noise from animal movement, even when the animal is fairly docile during sleep or other activity. The thresholds, time periods, and combinational approaches used in the determinations described above may be adjusted based on different factors, such as living environment of the livestock and/or type of livestock.

If a determination is made in block 46 that the tag 10 is detached from the object 12, then a signal may be transmitted from the tag 10 to the host computing system 28 in block 48. The signal may inform the host computing system 28 that the tag 10 has become detached. For this purpose, the signal may include a unique identifier of the tag 10. This unique identifier may have been previously associated with the object 12 in the host computing system 28 so that it will be known which object 12 has become separated from its tag 10. In this manner, the host computing system 28 and/or a human user of the host computing system 28 may be alerted to the detached state of the tag 10 for a specific object 12. This may be useful information when trying to locate a particular object 12, during inventory control situations such as when the objects 12 move in mass past a scanner or reader that reads the identities of the tags 10 as the objects pass nearby (e.g., by using RFID technology), or in other situations.

The host computing system 28 may include a user interface that displays information and/or provides other functionality. For example, the user interface may display identification information about each tag 10 or object 12 that has become separated, the total number of tags 10 still attached to their associated objects 12 and the total number of tags 10 that are detached from their associated objects 12, or other information. In one embodiment, the user may employ the user interface to activate a transponder in a particular detached tag 10 or a particular attached tag 10 to assist in locating the tag 10 or object 12 using triangulation.

If a signal informing the host computing system 28 that the tag 10 has become detached is sent in block 48 and the tag 10 later detects changes in orientation, then another signal may be transmitted from the tag 10 to the host computing system 28 that the earlier signal was possibly the result of a false positive determination of tag 10 detachment. In this manner, the determination of tag 10 detachment may be retracted.

Also, to assist in reducing the incidence of false-positives, a learning approach to determining appropriate thresholds, time periods, and combinational approaches may be employed. For this purpose the normalized samples may be transmitted to the host computing system 28 during a set-up phase. During the set-up phase, the host computing system 28 may analyze the samples and determine the exact thresholds and approaches to be used by the tag 10 in steps 44 and 46. In another approach, the signal of block 48 may include the normalized samples and/or the rotational shift value or values upon which the detachment determination was made. If the host computing system 28 determines that there are a relatively high number of false positives generated by the deployed tags 10, then the additional data included in the received signals may be analyzed and thresholds, time periods, and/or combinational approaches may be adjusted to reduce the incidence of false positive tag detachment results.

Although certain embodiments have been shown and described, it is understood that equivalents and modifications falling within the scope of the appended claims will occur to others who are skilled in the art upon the reading and understanding of this specification.

1-21. (canceled)

22. A tag configured to be attached to an object, comprising:
a sensor configured to generate data indicative of movement of the tag in three dimensions; and
a control circuit configured to:
determine an amount of change in orientation of the tag over a predetermined period of time based on the data indicative of movement of the tag in three dimensions generated by the sensor; and
determine that the amount of change in orientation indicates that the tag is in one of an attached state relative to the object or is in a detached state relative to the object.

23. The tag of claim 22, further comprising a communications circuit and wherein the tag is configured to, upon determination that the tag is in the detached state relative to the object, output a signal indicating the detached state of the tag over the communications circuit to a host computing system.

24. The tag of claim 23, wherein the sensor is an accelerometer assembly and wherein determining the amount of change in the orientation comprises:
sampling data output by the accelerometer assembly at a plurality of points in time; and
normalizing each sample.

25. The tag of claim 24, wherein the samples are taken at predetermined intervals.

26. The tag of claim 24, wherein determining the amount of change in the orientation further includes comparing each normalized sample with a prior normalized sample to determine a rotational shift value between each pair of compared samples.

27. The tag of claim 24, wherein the determining the amount of change in orientation further includes carrying out a predetermined operation on a plurality of the normalized samples to determine one or more rotation shift values.

28. The tag of claim 26, wherein the tag is determined to be in the detached state if the rotational shift values show rotational shift of less than a predetermined threshold over the predetermined amount of time.

29. The tag of claim 26, wherein the determining that the amount of change in orientation indicates that the tag is in the one of the attached state relative to the object or is in the detached state relative to the object includes conducting a statistical analysis of the rotational shift values.

30. The tag of claim 22, wherein the object is a livestock animal, and
wherein one or more thresholds used in determining that the amount of change in orientation indicates that the tag is in the one of the attached state relative to the object or is in the detached state relative to the object is dependent on the type of animal.

31. The tag of claim 22, wherein one or more thresholds used in determining that the amount of change in orientation indicates that the tag is in the one of the attached state relative to the object or is in the detached state relative to the object is established using a learning algorithm.

32. An object tracking system, comprising:
a plurality of tags, each in accordance with claim 22, and each associated with a corresponding one of a plurality objects; and
a host computing system, the host computing system collecting data regarding the plurality of objects.

33. The object tracking system of claim 32, wherein the host computing system applies a learning algorithm to change settings used in the determining that the amount of change in orientation indicates that the tag is in the one of the attached state relative to the object or is in the detached state relative to the object to increase accuracy of the determination.

34. A method of determining attachment of a tag to an object, comprising:
collecting sensor output data indicative of movement of the tag in three dimensions;
determining an amount of change in orientation of the tag over a predetermined period of time from the data indicative of movement of the tag in three dimensions; and
determining that the amount of change in orientation indicates that the tag is in one of an attached state relative to the object or is in a detached state relative to the object.

35. The method of claim 34, further comprising, upon determination that the tag is in the detached state relative to the object, outputting a signal indicating the detached state of the tag to a host computing system.

36. The method of claim 34, wherein the sensor is an accelerometer assembly and determining the amount of change in the orientation includes:
sampling data output by the accelerometer assembly at a plurality of points in time; and
normalizing each sample.

37. The method of claim 36, wherein the samples are taken at predetermined intervals.

38. The method of claim 36, wherein determining the amount of change in the orientation further includes comparing each normalized sample with a prior normalized sample to determine a rotational shift value between each pair of compared samples.

39. The method of claim 36, wherein the determining the amount of change in orientation further includes carrying out a predetermined operation on a plurality of the samples to determine one or more rotation shift values.

40. The method of claim 39, wherein the tag is determined to be in the detached state if the rotational shift values show rotational shift of less than a predetermined threshold over the predetermined amount of time.

41. The method of claim 39, wherein the determining that the amount of change in orientation indicates that the tag is in the one of the attached state relative to the object or is in the detached state relative to the object includes conducting a statistical analysis of the rotational shift values.
